(19) United States
(12) Patent Application Publication
(10) Pub. No.: US 2005/0067895 A1
(43) Pub. Date: Mar. 31, 2005

(54) Apparatus and method of monitoring braking system pressure

(76) Inventor: Sameer S. Marathe, Naperville, IL (US)

Correspondence Address: CATERPILLAR INC.;100 N.E. ADAMS STREET, PATENT DEPT., PEORIA, IL, 616296490, US

(21) Appl. No.: 10/670,857

(22) Filed: Sep. 25, 2003

(51) Int. Cl. B60T 8/88

(52) U.S. Cl. 303/122.09; 303/122.08; 303/122.04

(57) ABSTRACT

A monitoring apparatus for monitoring system pressure in a braking system of a vehicle is disclosed. The monitoring apparatus includes at least one pressure detection device for measuring system pressure and responsively producing an output signal, and at least one monitoring device for receiving said output signal and sampling said output signal at pre-determined intervals continually during operation of the vehicle.

### TECHNICAL FIELD

This invention relates generally to the field of brakes and, more particularly, to an apparatus and method related to continually monitoring braking system pressure during the operation of vehicle.

### BACKGROUND

A work machine such as a wheel loader, motor grader, scraper, or any machine that is with a hydraulic braking system requires pressurized fluid to either actuate or disengage the brakes. In order to have proper and instantaneous braking force during a braking event, the hydraulic braking system may utilize at least one accumulator to provide fluid pressure to the brakes until such time as the pump has time to satisfy the pressure needs of the event.

The accumulator is generally divided into two chambers. The first chamber is open to system fluid and the consequent fluid pressures in the braking system. The second chamber is in a cooperating arrangement with the first chamber, and, in a gas type accumulator, is charged with a nitrogen gas to a pre-determined pressure, hereinafter known as the accumulator charge pressure. Upon starting the work machine, the pump supplies fluid to the braking system. The accumulator chamber open to the system fluid fills with fluid. Once full, pressure begins to build against the nitrogen charged chamber, consequently compressing the already precharged nitrogen gas. After the pressure in the system and the accumulator has built to a maximum pre-determined pressure, the pressure is confined in the system until the pressure is needed in a braking event.

It is well known in the art that a binary pressure switch is used to detect low pressure in the braking system. Although this is a means of detecting low pressure, it is not a good source for troubleshooting a braking system. Many conditions could help in detecting and isolating a brake system problem, but because of the binary nature of a pressure switch there is no pressure data for computing the conditions. Some of these conditions include estimated charge pressure, “cut-in pressure”, “cut-out pressure”, and the time it takes to charge the accumulator. As used herein, the “cut-in pressure” occurs after initial charging of the braking system and is the pressure at which the pump is activated to pressurize the system and charge the system to the “cut-out pressure”, which is the pressure at which the pump is deactivated.

It is not uncommon for the accumulator to be replaced when a low-pressure warning is given, regardless if the accumulator is the problem. To avoid unnecessarily replacing accumulators there is a need for a reliable and easy way to detect and monitor accumulator charge pressures, along with other conditions set forth above. U.S. Pat. No. 3,662,333, issued May 9, 1972, to Donald W. Howard discloses a monitoring system that monitors the accumulator charge pressure during a braking event. However the '333 invention is not a reliable way to monitor pressures because the change in accumulator pressure during a braking event is very abrupt. In addition, pressure decay can vary with the service state of the brakes, adding uncertainty.

The present invention is directed to overcoming one or more of the problems set forth above.

### SUMMARY OF THE INVENTION

In an embodiment, a monitoring apparatus for monitoring system pressure in a braking system of a vehicle is disclosed. The monitoring apparatus includes at least one pressure detection device for measuring system pressure and responsively producing an output signal and at least one monitoring device for receiving said output signal and sampling said output signal at pre-determined intervals continually during operation of the vehicle.

In another embodiment, a method of monitoring system pressure in a braking system of a vehicle is disclosed. The method of monitoring system pressure includes the steps of providing at least one pressure detection device for measuring system pressure and responsively producing an output signal and providing at least one monitoring device for receiving said output signal and sampling said output signal at pre-determined intervals continually during operation of the vehicle.

### BRIEF DESCRIPTION OF THE DRAWINGS

FIG. 1 is a diagrammatic view of an embodiment of the pressure monitoring apparatus of the present invention; and

FIG. 2 is a flowchart of the embodiment of the pressure monitoring apparatus of FIG. 1.

### DETAILED DESCRIPTION

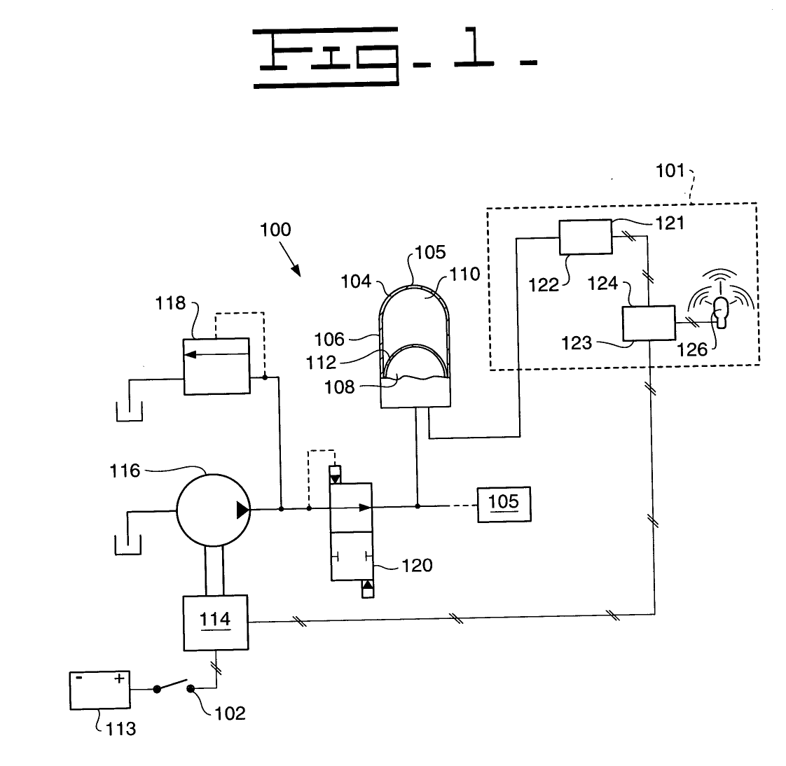

FIG. 1 is a diagrammatical view of a braking system 100 of a vehicle (not shown), incorporating a pressure monitoring apparatus 101. As shown, the braking system 100 is the type having an activation switch 102 for activating the vehicle. The braking system 100 also includes a pressure storage device 104, which in the embodiment shown is an accumulator 105 of the type having at least two chambers 108, 110 housed in an accumulator body 106. The first chamber 108 is in communication with the system fluid, and the second chamber 110 is in a cooperating arrangement with the first chamber 108 through a diaphragm 112. The second chamber 110 is precharged with a nitrogen gas to a pre-determined pressure, although other means may be used to precharge the second chamber 110, such as a spring or other types of gases. As fluid pressure builds in the first chamber 108, the pressure acts upon the diaphragm 112, thereby compressing the already precharged nitrogen gas in the second chamber 110.

An energy source 113, which is shown for exemplary purposes as being a battery, is coupled to the activation switch 102, which may be a toggle switch, push-button, key, or other like device. The activation switch 102 is coupled to a power source 114. The power source 114, such as an internal combustion engine, is coupled to the pump 116, which may be a fixed displacement pump (shown), a variable displacement pump, or another suitable pump apparatus. The braking system 100 may also include a pressure relief valve 118 for relieving excess pressure in a known manner, and an accumulator charge valve 120 used to regulate the pressure in the pressure storage device 104.

The pressure monitoring apparatus 101 includes a pressure detection device 121, which in the embodiment shown is a pressure transducer 122. Although a pressure transducer 122 is shown, any device that outputs a signal with respect to pressure input could be used. The pressure transducer 122 is well known in the art for outputting a voltage signal proportional to the pressure input. The pressure detection device 121 is coupled to the first chamber 108 of the accumulator 105, and outputs a pressure signal indicative of the pressure of the braking system 100. Alternatively, the pressure detection device 121 may be coupled to the second chamber 110.

The pressure monitoring apparatus 101 includes a monitoring device 123, such as a programmable electronic control module (ECM) 124, adapted to receive the pressure signal from the pressure detection device 121 and produce a pressure signal in response thereto. The pressure monitoring apparatus 101 includes an alarming device 126, which may comprise an audible, visible or other type of device suitable for alerting the operator of abnormal behavior in the braking system.

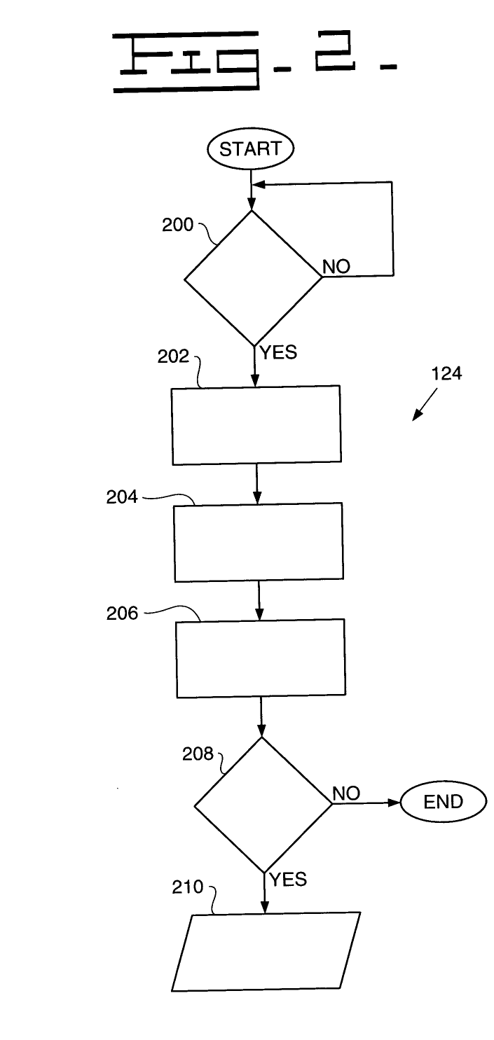

FIG. 2 is a flowchart depicting an embodiment of an algorithm for use with the fluid pressure monitoring apparatus 101. Control starts at decision block 200, which determines if there has been a vehicle start event through monitoring the revolutions per minute (RPM) of the power source 114. Upon a signal from the power source 114 that the RPM has reached a pre-determined magnitude, control passes to block 202 in which the ECM 124 starts a timer for time stamping the estimated charge pressure and other conditions as described hereinafter, and starts monitoring the pressure signal received from the pressure detection device 121 at a pre-determined sampling rate.

Next, control passes to block 204 where the first “pressure sampling point”, which represents the initial charge pressure of the accumulator 105, is read. Each pressure sample point thereinafter is compared to criteria stored in the memory of the ECM 124. If a pressure sample point being evaluated by the ECM 124 is found to be greater than the recorded charge pressure, and the change in pressure is less than a pre-determined value, the pressure sample point is discarded by the ECM 124 and not stored. If the pressure sample point does not meet the criteria of either exceeding the recorded charge pressure or the change in pressure less a pre-determined value, the pressure sample point replaces the recorded charge pressure to become the newly recorded charge pressure. Pressure sampling for the charge pressure continues for a pre-determined period of time. Although only one time period is necessary for determining the accumulator charge pressure, for exemplary purposes, three time periods of 0.2s, 0.6s, and 1s are used. This redundancy raises the confidence level of the accuracy of the charge pressure in the following manner.

At the end of each exemplary time period a charge pressure is recorded as the charge pressure of the accumulator 105, giving three recorded charge pressures. In the case where the three charge pressures have a difference in value within a predetermined limit of each other, the highest charge pressure of the three is recorded as the charge pressure of the accumulator 105 and carried through the rest of the algorithm. In the case when two of the three charge pressures have a difference in value within the pre-determined limit of each other, the non-compliant charge pressure is discarded and the higher charge pressure of the two remaining compliant charge pressures is recorded as the charge pressure of the accumulator 105 and carried through the rest of the algorithm. In the case when the three charge pressures have a difference in value outside the pre-determined limit of each other, a conclusion is made that there was a failure in the routine and there is no recorded charge pressure to be carried through the rest of the algorithm. The time it takes to reach the charge pressure is determined by time stamping the charge pressure when it is recorded. In the aforementioned cases where the charge pressure being carried through the rest of the algorithm is the higher of two or the highest of three charge pressures, the best time of the two or three charge pressures, depending on the instance, is used as the time it takes to charge the accumulator 105. Control then passes to block 206 wherein the charge pressure is compared to a pre-determined limit. Decision block 208 determines if the charge pressure exceeds the predetermined limit, and if it does, the ECM 124 generates a fault signal and control passes to block 210 causing activation of the alarming device 126.

Other conditions may be monitored through continual sampling, such as “cut-in pressure”, “cut-out pressure”, as these terms are defined below, and loss of pressure in the braking system 100 below a pre-determined limit.

The “cut-out pressure”, defined as a high point pressure at which the pump is shut off and pressure is confined in the braking system 100, is computed in block 204 and recorded in the ECM 124. This routine records the initial sample point as the cut-out pressure and monitors the aforementioned sequential pressure sample points. If the sample point being evaluated by the ECM 124 is higher than the recorded pressure, the sampling point pressure replaces the previously recorded pressure, and becomes the cut-out pressure. If the pressure sample point is not appreciably greater than the recorded cut-out pressure, the recorded cut-out pressure is carried through to the next step in the algorithm. Control then passes to block 206 wherein the cut-out pressure is compared to a predetermined limit. Decision block 208 determines if the cut-out pressure exceeds the pre-determined limit, at which time the ECM 124 generates a fault signal and control passes to block 210 causing activation of the alarming device 126.

The “cut-in pressure”, defined as a low point pressure at which the pump is turned on and pressure builds back up in the braking system 100, is computed in block 204 and recorded in the ECM 124. This routine begins upon the occurrence that the pressure sample point is less than the recorded cut-out pressure. Upon this occurring the pressure sample point is recorded and is the initial cut-in pressure. If the sample point is less than the recorded cut-in pressure, the pressure sample point replaces the previously recorded pressure, and becomes the new cut-in pressure. If, the pressure sample point is not being appreciably less than the recorded cut-in pressure, the recorded cut-in pressure is carried through to the next step in the algorithm. Control then passes to block 206 wherein the cut-in pressure is compared to a pre-determined limit. Decision block 208 determines if the cut-in pressure exceeds the predetermined limit, at which time the ECM 124 generates a fault signal and control passes to block 210 causing activation of the alarming device 126.

The loss of pressure in the braking system 100 is computed in block 206 wherein the present sample point is compared to a pre-determined limit. Decision block 208 determines if the present sample point is below the pre-determined limit, at which time the ECM 124 generates a fault signal and control passes to block 210 causing activation of the alarming device 126.

### INDUSTRIAL APPLICABILITY

The monitoring apparatus is intended to monitor the fluid pressure in a braking system 100 having an activation switch 102 for system operation.

The vehicle is brought into operation through the activation switch 102 being placed in the “on” position, thereby allowing the power source 114 to start and generate RPMs. The pump 104 is coupled to the power source 114 and provides fluid flow and consequently pressure to the braking system 100, which includes at least one accumulator 105. Pressure in the braking system 100 will rapidly increase to the accumulator charge pressure of the accumulator 105. The accumulator charge pressure is the pressure at which the accumulator 105 was precharged with nitrogen gas. Once the accumulator charge pressure is reached, the rate of pressure will build at a decreased rate, until such a time as the cut-out pressure is reached. Pressure in the braking system will oscillate between the cut-in pressure and the cut-out pressure during the operation of the vehicle

To monitor fluid pressure in the braking system, a pressure detection device 121 and monitoring device 123 are provided to produce a signal related to pressure and to monitor the signal, respectfully. Upon receiving a signal from the power source 114 that RPMs has reached a pre-determined limit, signifying a vehicle start event has occurred, the monitoring device 123 starts to continually sample the signal from the pressure detection device 121 at a pre-determined rate. The signal from the pressure detection device 121 is that of a voltage signal proportional to the pressure in the braking system.

The monitoring device 123 is adapted to receive the voltage signal from the pressure detection device 121 and perform computations based on a set of conditions. The conditions being monitored are as follows: estimated charge pressure, cut-in pressure, cut-out pressure, and time it takes to charge the accumulator 105. As the sample points are brought into the monitoring device 123, the monitoring device 123 is adapted to store the conditions and compare the condition's pre-determined limits. If a condition exceeds its corresponding limit, a fault signal is produced. The monitoring device 123 sends the fault signal to an alarm device 126, which comprises a means of alerting the operator of abnormal behavior in the braking system 100.

By having the means for continually monitoring and storing vital braking system 100 information, as set forth above, such as, accumulator charge pressure, cut-in pressure, cut-out pressure, and other conditions, the unnecessary replacement of braking components, such as, accumulators, may be reduced.

Other aspects, objects and advantages of this invention can be obtained from a study of the drawings, the disclosure, and the appended claims.

1. A braking system comprising:
an accumulator providing a supply of hydraulic braking fluid to the braking system for use in applying a brake, the accumulator having an accumulator charge pressure;
a pressure detection device which measures the pressure of the hydraulic braking fluid in the accumulator and responsively producing an output signal;
a monitoring device which receives the output signal; and
the monitoring device being capable of using the output signal to determine the accumulator charge pressure, comparing the accumulator charge pressure to a pressure limit, and using the results of the comparison in generating a fault signal.

2-9. (Cancelled)

10. A method of monitoring hydraulic braking fluid pressure in a braking system of a vehicle, the braking system including an accumulator, the method comprising:
measuring the pressure of the hydraulic braking fluid and responsively producing an output signal;
processing the output signal to estimate an accumulator charge pressure; and
comparing the estimate of the accumulator charge pressure with an ideal value.

11-14. (Cancelled)

15. The braking system of claim 1 wherein the monitoring device records the pressure of the hydraulic braking fluid in the accumulator within a fixed amount of time after a braking system start-up is detected to determine the accumulator charge pressure.

16. The braking system of claim 15 wherein the monitoring device is further capable of determining a cut-in pressure of the braking system and comparing the cut-in pressure to a cut-in pressure limit, the monitoring device using this comparison in generating a fault signal.

17. The method of claim 10 wherein comparing the estimate of the accumulator charge pressure with an ideal value further comprises:
calculating a difference between the estimate of the accumulator charge pressure and the ideal value to produce an error value.

18. The method of claim 17 further comprising:
comparing the error value to a preset limit value and using that comparison to determine whether a fault signal should be generated.

19. The method of claim 10 wherein processing the output signal to estimate an accumulator charge pressure further comprises comparing several hydraulic braking fluid pressures and determining which one is the best estimate of the accumulator charge pressure.

20. The method of claim 19 wherein processing the output signal to estimate an accumulator charge pressure further comprises sampling each of the several hydraulic braking fluid pressures at predetermined times after a braking system start-up is detected.

21. A braking system comprising:
an accumulator providing a supply of pressurized hydraulic braking fluid to the braking system for use in applying a brake, the accumulator comprising at least a first chamber for hydraulic braking fluid which has a first volume when the hydraulic braking fluid is less than a first pressure, and which expands to a volume greater than the first volume when the hydraulic braking fluid is greater than the first pressure;
a pump which when actuated provides pressurized hydraulic braking fluid to the first chamber of the accumulator;
a pressure detection device which measures the pressure of the hydraulic braking fluid in the first chamber of the accumulator and responsively producing an output signal;
a monitoring device which receives the output signal of the pressure detection device, wherein the monitoring device identifies an estimate of the first pressure of the hydraulic braking fluid, and uses the estimate of the first pressure in determining whether to produce a fault signal.

22. The braking system of claim 21 wherein the monitoring device identifies the estimate of the first pressure by recording the pressure of the hydraulic braking fluid in the first chamber of the accumulator at a time immediately after the first chamber expands beyond the first volume.

23. The braking system of claim 21 wherein the monitoring device identifies the estimate of the first pressure by recording several pressures of the hydraulic braking fluid in the first chamber of the accumulator within a predetermined time after a braking system start-up is detected.

24. The braking system of claim 23 wherein the monitoring device selects one of the several pressures to be the first hydraulic braking fluid pressure.

25. A braking system comprising:
an accumulator providing a supply of pressurized hydraulic braking fluid to the braking system for use in applying a brake, the accumulator comprising at least a first chamber for hydraulic braking fluid which has a first volume when the hydraulic braking fluid is less than a first pressure, and which expands to a volume greater than the first volume when the hydraulic braking fluid is greater than the first pressure, the accumulator further comprising a second volume a having a pressurized precharge gas, the second volume also having a cooperative relation with the first volume whereby the second volume contracts when the first volume expands, and the second volume expands when the first volume contracts;
a pump which when actuated provides pressurized hydraulic braking fluid to the first chamber of the accumulator;
a pressure detection device which measures one of the pressure of the hydraulic braking fluid in the first chamber of the accumulator or the pressure of the precharge gas in the second chamber of the accumulator, and responsively producing an output signal;
a monitoring device for receiving the output signal of the pressure detection device, wherein the monitoring device samples one of the pressure of the hydraulic braking fluid in the first chamber of the accumulator, or the pressure of the precharge gas in the second chamber of the accumulator, in response to a detection of a braking system start-up, and uses the one of the sample of the hydraulic braking fluid pressure or the precharge gas pressure in determining whether to produce a fault signal.

26. The braking system of claim 25 further comprising a pressure sensitive valve in communication with the pump and the accumulator having a cut-in pressure and a cut-out pressure, the valve opening to permit pressurized hydraulic braking fluid to flow from the pump to the accumulator when the pressure of the hydraulic braking fluid in the first chamber of the accumulator falls below the cut-in pressure, and the valve closing to prevent pressurized hydraulic braking fluid from flowing from the pump to the accumulator when the pressure of the hydraulic braking fluid in the first chamber of the accumulator rises above the cut-out pressure.

27. The braking system of claim 26 wherein the monitoring device identifies the cut-in pressure and the cut-out pressure of the valve by monitoring one of the pressure of the hydraulic braking fluid in the first chamber of the accumulator or the pressure of the precharge gas in the second chamber of the accumulator.
